(19) United States
(12) Patent Application Publication
(10) Pub. No.: US 2015/0205862 A1
(43) Pub. Date: Jul. 23, 2015

(54) Method and device for recognizing and labeling peaks, increases, or abnormal or exceptional variations in the throughput of a stream of digital documents

(71) Applicants: Jean-Charles Campagne, Paris (FR); Paul Guyot, Paris (FR); David Julien, Saint-Germain-en-Laye (FR)

(72) Inventors: Jean-Charles Campagne, Paris (FR); Paul Guyot, Paris (FR); David Julien, Saint-Germain-en-Laye (FR)

(21) Appl. No.: 14/005,803

(22) PCT Filed: Mar. 16, 2012
(86) PCT No.: PCT/EP2012/054666

§ 371 Date: Feb. 19, 2015

(30) Foreign Application Priority Data
Mar. 18, 2011 (FR) 1100817

(51) Int. Cl. G06F 17/30

(52) U.S. Cl. CPC G06F 17/30699; G06F 17/30011

(57) ABSTRACT

Method and device for recognizing and labeling peaks, increases, or abnormal or exceptional variations in the throughput of a stream of digital documents.

The invention relates to a method and a device which make it possible to produce an explanatory view of the variations in the throughput of a stream of documents, or to alert an operator by indicating the main subjects of the abnormal variations in said throughput.

The device implements a method (1) of recognizing the periods during which the throughput of a stream of documents varies abnormally, a method (2) of morphologically analyzing text, a method (3) of determining, for a given period, the character strings of which the frequencies are the highest for the documents of the period, and a method (4) of building a label from the strings identified by said method (3). The device can be coupled to an alerting (23) or display (22) system.

The method and the device according to the invention are particularly intended for social media monitoring.

The field of the invention is telecommunications and, especially, the analysis of streams of digital documents. The invention also applies to the analysis of huge sets of digital documents. These digital documents can be electronic mail messages or GSM short messages or messages or articles and comments posted on websites, blogs, forums or social networks, or instant messages, or any other type of message or digital document posted or published, as text or including text or that can be scanned by a device generating text like a speech recognition device. These digital documents can be directed specifically or implicitly at recipients or be made public for a community or for everyone. These digital documents are associated with one or more dates of publication, mailing or modification.

The present invention relates to a method and a device for identifying and labeling peaks, increases or abnormal or unusual variations in the throughput of a stream of documents from one or more social networks or a collection of blogs or websites, in order to alert an operator or to produce a synthetic explanatory view of the variations of the throughput.

The general problem is to produce a synthetic explanatory view of the variations of the throughput of a stream of digital documents, or to alert an operator by indicating the main topics explaining or supporting defects or abnormal or unusual variations in said throughput.

There are a number of devices that produce or are used to produce charts showing the time on the x-axis and the throughput on the y-axis (number of documents per unit of time). These devices allow operators to explore the documents that have been published at a time or during a given period. Some of these de-vices allow to highlight peaks, increases or abnormal or unusual variations in throughput or to alert an operator when such a variation occurs. Such devices implement different methods for dating and measuring abnormal or unusual variations in throughput of a stream of documents. One of these methods is to compare the throughput at a given time with the average throughput over a longer period of time. More advanced methods rely on transforms, for example discrete wavelet transform, as described by A. Haar in the article “Zur Theorie der orthogonalen Funktionensysteme” published in Mathematische Annalen 69, 1910, no. 3, pp. 331-371; there is an abundant literature about detection of peaks from such transforms like the international patent application WO 2010/007486, or detection of anomalies like the communication of C. T. Huang et al. entitled “Wavelet-based Real Time Detection of Network Traffic Anomalies” in Securecomm Workshops and published in 2006 by IEEE.

These traditional methods for detecting abnormal or exceptional variations in the throughput of a stream of documents do not provide qualitative information to explain these variations. To describe these variations, and especially to associate an external event such as a communication operation or a crisis, the operator is traditionally required to explore documents composing the observed peaks. This task can be particularly tedious. In particular, when the normal throughput of documents is important, for instance thousands of documents per hour, a percentage and a significant number of documents do not address the topic of a peak and cannot explain observed variations. The operator can be easily overwhelmed by the huge amount of documents.

There are also devices to determine the most present topics in a stream of documents, or the topics whose presence increases significantly. For instance, sites like SEARCH.TWITTER.COM, TWIRUS.COM and BING.COM display lists of “trending topics” on social networks. These lists may be built from the derivative of the frequency of morphemes or group of morphemes in the analyzed documents, as described in the blog post of C. Penner, entitled “To Trend or Not to Trend . . . ”, published in 2010 on BLOG.TWITTER.COM. Other techniques to build such lists are based on a measure of entropy or on the product called “TF-IDF” and are described in the report of J. Benhardus entitled “Streaming Trend Detection in Twitter” and released at the UCCS REU for Artificial Intelligence, National Language Processing and Information Retrieval 2010. “TF-IDF” product and term-weighting methods are described in particular in “Term-weighting approaches in automatic text retrieval” Salton, G. et al. published in 1988 in Information Processing and Management, Vol. 24, N. 5, pp. 513-523. However, if these techniques allow to highlight words or phrases at a given time in a stream as wide as the public Twitter messages, they do not produce a synthetic explanatory view of the peaks or of the significant variations in the throughput of a stream of documents related to a given topic.

Prior art solutions that allow an analyst, for example a sociologist, a market researcher or a commentator, to apprehend very large volumes of information in real time, with no presupposition on explanatory models, are technically limited by the volume of data considered.

Known solutions require technical equipments to access a digital stream of messages and documents. These equipments are toots installed on servers, permanently connected to continuous streams of digital information on social networks via a software interface (API), and also continuously requesting pages from servers hosting websites of blogs or forums, in order to download locally selected digital documents. All these collected documents constitute a stream of digital documents.

These technical equipments generate large volumes of digital data, ranging from about several tens of thousands to millions of messages or articles per day.

A possible solution for understanding these volumes of information would be to read and classify each digital document to infer an interpretation thanks to a human analysis. This solution is not reasonable when the throughput is huge (several thousands to several millions of documents per day) or when the explanation must be provided in a short period of about a minute.

Known solutions yield charts of information throughput over time for either the entirety of a given stream of documents or for a selection corresponding to predetermined specifications (for example the stream of documents containing a word or a combination of terms). Thus, powerful computing resources could be used to verify assumptions or hypotheses previously defined by the analyst, assumptions which have to be expressed as predefined queries that determine a subset of the stream of documents.

In other words, these powerful computing resources do not provide the analyst with explanatory models. They can only be used to test hypotheses. A person skilled in the art, faced with this technical problem, would have an approach consisting in increasing infinitely the number of hypotheses, and check which of these hypotheses, applied on the volume of data available, generates a chart consistent with an explanatory model.

It is obvious that the processing time increases exponentially with:
the amount of digital documents to process;
the amount of hypotheses submitted by the analyst.

Therefore, the analyst would not be able to draw relevant information in a timely manner.

The technical problem to solve is the ability to process in real-time large volumes of data to conduct analyzes in order to explain variations in volume or throughput, indicative of external events.

The method according to the invention overcomes the disadvantages of traditional approaches. For this purpose, the invention proposes a technical process, executed by a computer, comprising a series of processing steps:
in a first step, the data stream is processed to characterize quantitative peaks (this step identifies regime shifts in the throughput). This step consists in determining one or several time intervals and controls recording of digital documents for these intervals for further processing;
in a second step, character strings from the above-mentioned documents are extracted by partitioning text and by storing in another recording memory the identified strings;
a third step consists in creating an index of extracted strings from the second step, and to associate each string to the corresponding documents and to a quantitative indicator that measures the importance of this string within these documents relatively to whole stream of digital documents, and then to determine the most important character strings according to this quantitative indicator;
a final step consists in building a label from the documents associated with the strings identified in the third step.

It is no mere intellectual methods, as a human operator would in no way be able to achieve all of these different stages and treatments. Moreover, all of these steps involve digital data without direct cognitive reality.

The invention comprises, according to a first feature:
a first method to identify periods when the throughput of a stream of digital documents varies in an abnormal or exceptional manner, or form a peak or significantly increases;
a second method of morphological analysis for extracting strings from a digital document and for distinguishing among those strings, those that correspond to morphemes or groups of morphemes from those corresponding to separators between morphemes or morpheme groups;
a third method for determining, for each of these periods, character strings extracted by the above method which frequencies are the highest for digital documents within each period distinguished by the first method compared to digital documents outside these periods;
a fourth method to build, for all or a subset of periods distinguished by the first method, a label from all or a sample of the digital documents within this period and from a subset or from all strings distinguished by the preceding method.

According to particular embodiments:
the first method operates like a low-cut (or high-pass) filter based on wavelets. Documents are counted per unit of time (hour, day), and the sequence thus determined forms a signal on which a fitter is carried out, eliminating coefficients of the discrete wavelet decomposition that are below a certain threshold in absolute value. Distinguished periods are defined as periods during which the reconstructed signal after filtering has a positive value. Compared to the naive and obvious to the skilled-of-the-art approach, which would consist in comparing the number of documents per unit of time with the average, this approach has the double advantage of identifying peaks or exceptional increases even when the average rate is high but lower than the recent average rate, and of limiting the peak periods more accurately than just an exceeding of average;
the first method operates by comparing the signal with a periodic or quasi-periodic model. Such a model is established a priori, such as a linear combination of periodic functions of periods of 24 hours or 7 days. The model coefficients are obtained by the least-squares method based on historical data. Distinguished periods are defined as periods during which the difference between the model and the signal is above a certain threshold. This approach has the same advantages as the previous approach compared to the naive approach. Furthermore it can detect smaller peaks in a more precise way, especially when the signal is highly periodic, as it can be seen in social networks where activity is highly dependent on diurnal and weekly rhythms. However, compared to the previous approach, this approach has the disadvantage of being heavier and requires to develop a model of the analyzed stream. This approach cannot detect peaks that are recurring and periodicals on historical data;
the second method is a division of digital documents according to spaces and punctuations. This approach has the advantage of being very simple and easy to implement. The division thus made does not correspond to a precise morphological analysis but is enough, in the context of the invention, to obtain labels for each of the peaks, increases or abnormal or exceptional variations of the throughput;
the second method is a division of digital documents thanks to a segmentation model based on statistical data, grammar, dictionary or hidden Markov models. Such a process could be for example one described in patent JP2897942. This approach has the advantage of being able to extract strings of digital documents written in languages where words are generally not separated by spaces or punctuations, such as Japanese, Chinese or Thai;
the second method consists firstly in identifying the language of the document and then in separating words using a method specifically tailored for the document language. This approach advantageously allows to treat a stream of digital documents in different languages;
the third method operates by removing strings, determined by the second method, included in an a priori list of stop-words. This approach has the advantage of avoiding building labels from stop words;
the third method operates by calculating the “TF-IDF” product for occurrences of character strings extracted by the second method, and then selecting one or more character strings for which this product is the highest;
the fourth method operates by searching the character string composed of a set of morphemes distinguished by the second method and present in the digital document that maximizes a function defined as the sum of frequencies of all of the sub-strings of this string in all digital documents;
the whole method is implemented in a device that presents the operator with a throughput chart and highlights the main peaks, increases or abnormal or unusual variations in the stream and displays statically or interactively, labels associated with these peaks, increases or abnormal or unusual variations;
the whole method is implemented in a device coupled with a filtering system that displays to the operator a throughput chart based on a subset of the analyzed stream, highlights the main peaks, increases or variations abnormal or exceptional variations in the stream and displays associated labels. This feature advantageously allows the operator to adjust the fitter to analyze more specifically the stream relative to these peaks, to get more information on these peaks or the rest of the chart, and possibly reveal other peaks;
the whole method is implemented in a device coupled to an alerting system or a notification system.

Other advantages and features of the invention will become apparent from the following description of an example of a preferred implementation referencing figures in the annex in which:

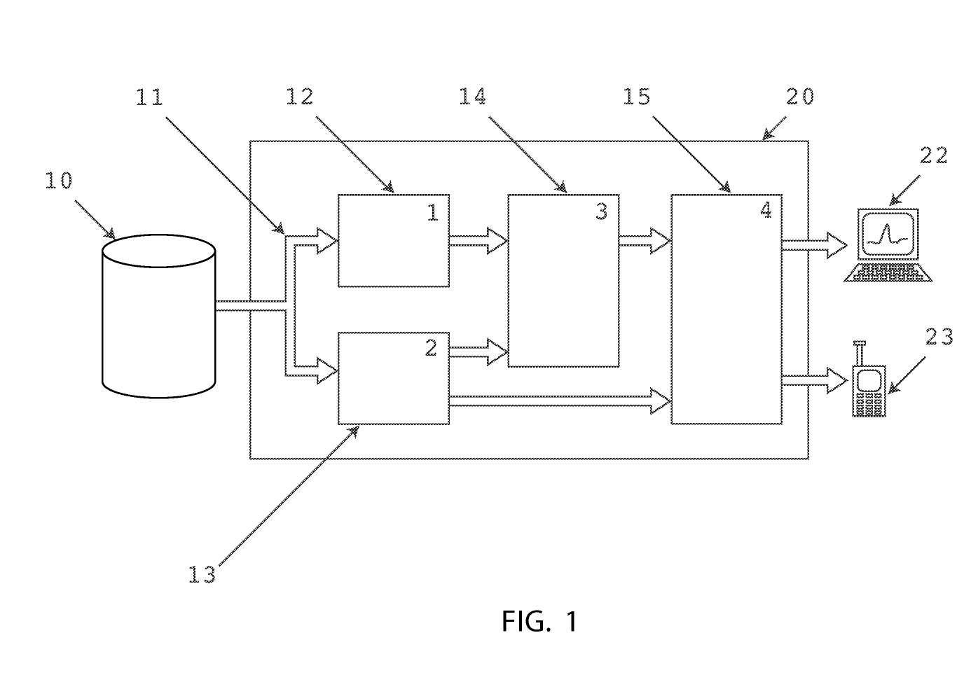

FIG. 1 shows a device implementing the methods;

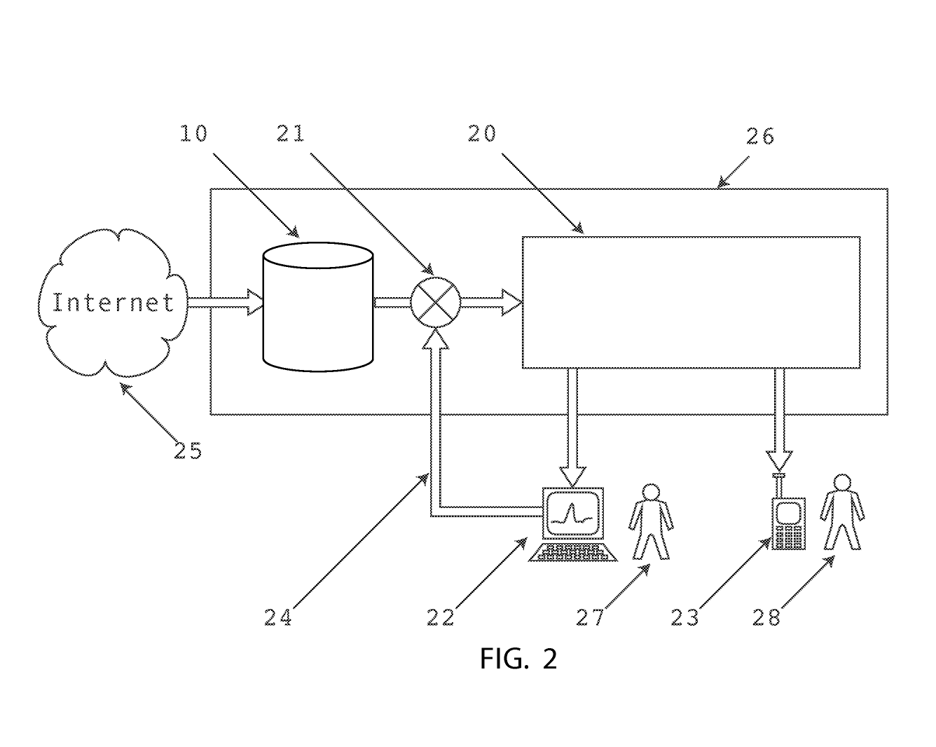

FIG. 2 shows a device that displays to the operator a throughput chart highlighting major peaks, increases or abnormal or unusual variations in the stream and which is coupled to a system of notification;

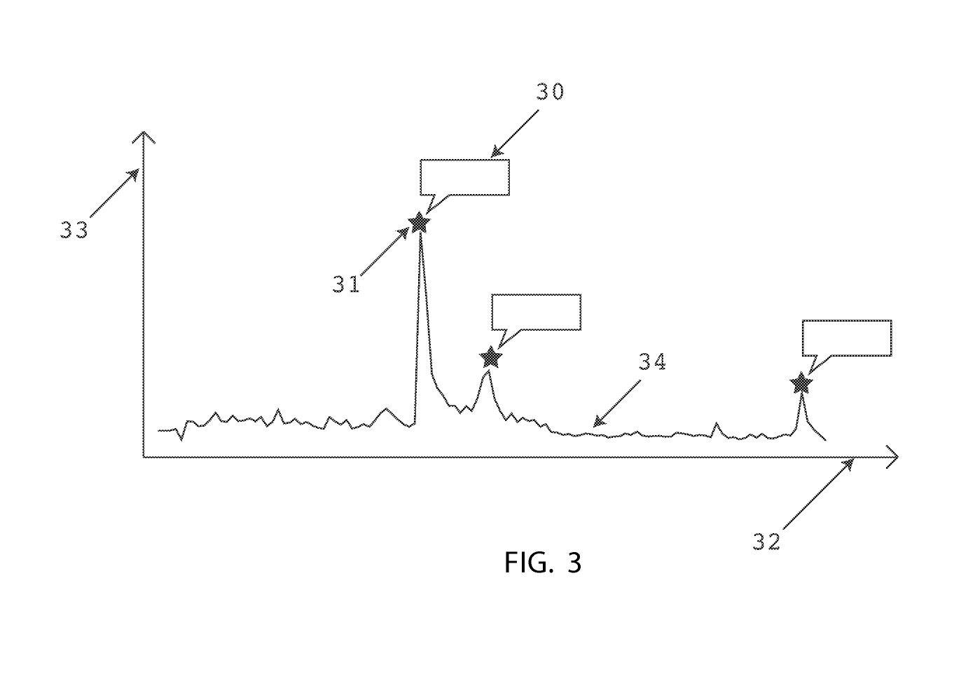

FIG. 3 shows a graph generated by the aforementioned device.

FIG. 1 shows the composition of the different methods and the stream (11) of digital documents through a device according to the invention.

Digital documents are at first stored in alphanumeric format in a table of a relational database (10). Each digital document is stored on a row including a column with the text of the document and a column with the date of publication of the document if it exists, or the date the document was retrieved, otherwise. For reasons of speed, the relational database is configured to index the date column with a clustered index, such as a B-Tree.

When the operator (27) queries the monitoring device (26), the device (12) first queries the relational database using the index mentioned above, to count, for each time period (hours or days), the number of documents stored in the database, according to a window defined by the operator. This information is used to draw the throughput chart of documents on the terminal (22) shown in FIG. 3. This chart can synthesize a huge volume of documents. This chart can be refreshed in real time when new documents are stored in the relational database (10).

The device (12) implements the method (1) to identify peak periods, or abnormal increases or exceptional variations. These peak periods can be highlighted by a marker (31) at the local maximum on the terminal interface (22).

Meanwhile, the device (13) queries the relational database using the index mentioned above to implement the method (2) in order to associate with each document, a sequence of character strings representing a morpheme or morpheme group. The documents associated with these sequences of character strings, and identified periods are then used by a device (14) implementing the method (3) to determine the most common character strings in each period identified according to all documents. This method (3) operates by first eliminating words that are part of a list of stop-words, then for each string the device computes the “TF-IDF” product and keeps the n character strings having the highest product, with n a process parameter whose value can be, for example, 5.

Finally, the documents, associated with the set of character of strings representing a morpheme or group of morphemes, and the n most common character strings for each identified period, are used by a device (15) implementing the method (4) which builds, for each of these periods, an associated label (30). This label (30) is built by searching the character string that includes one or more of the n character strings built by the device (14), which is included in the documents of the period, which is composed of a set of morphemes distinguished by the device (13), and which maximizes the function defined as the sum of frequencies of all sub-strings in the set of documents processed by the device (12).

FIG. 2 shows the integration of different methods of the invention in a larger monitoring device (26). Various streams are published on the internet (25) and are captured and stored in a relational database (10). These streams are filtered by a device (21) which determines the messages on a particular topic. The documents are then processed by a device (20) implementing a method according to the invention. This device displays to the operator (27) a chart like the one shown in FIG. 3 on the terminal (22). This chart shows various labels (30) allowing the operator (27) to interpret the peaks and abnormal or unusual variations of the throughput. This operator (27) can change the parameters of the filtering device (21) via a feedback loop (24). The device (20) then produces a new chart (34) representing the throughput according to the fitter parameters. This new chart has new peaks, increases or abnormal or unusual variations, which are identified by the device (20) and for which it produces new labels (30).

The device (20) is also coupled to a communication system which allows the operator (28) to receive an alert on the terminal (23) when the throughput has a peak, an increase or abnormal variation. This alert is associated with a label (30) which allows the operator (28) to determine the cause of the peak and decide whether it is necessary to analyze the change via the terminal (22) or by searching in digital documents that constitute the stream, which are stored in the database (10).

FIG. 3 shows a chart generated by a device according to the invention. The signal is represented as a chart with time on the x-axis (32) and the throughput per unit time on the y-axis (33). This signal forms a chart (34) with peaks identified by method (1) and highlighted by a marker at the local maximum (31). These markers are associated with labels (30).

In another embodiment of the invention, morphemes or groups of morphemes are extracted from digital documents, which are stored in a relational database with the list of associated morphemes, before method (1) identifies the peaks, increases or abnormal or unusual variations.

In another embodiment of the invention, when the volume of documents is too large to provide the operator with a response within a reasonable time, the device (13) queries the relational database (10) and fetches a uniform pseudo-random sample of digital documents. In another embodiment, this random sample is biased in favor of periods containing peaks and valleys revealed by the device (12). It appeared that sampling was justified when the number of digital documents stored in the relational database (10) and corresponding to the selection of the operator exceeds 10,000. In this case, the sample is limited to 10,000 documents, regardless of the actual volume of documents stored in the database.

In another embodiment of the invention, the relational database (10) is replaced by a buffer that can hold a number of digital documents and covering a period large enough to satisfy queries of the operator.

In another embodiment of the invention, digital documents are multimedia documents, and the method (2) of morphological analysis consists of a method for extracting text with speech recognition or optical recognition.

In another embodiment of the invention, the method (2) of morphological analysis is coupled to a method for automatic translation.

The method and device according to the invention are particularly suitable for social media monitoring.

1. Method for identifying and labeling main peaks, increases or abnormal or exceptional variations in a stream of digital documents initially stored in a database, characterized in that it comprises:
a period identification method for identifying periods when the throughput of the stream of digital documents varies in an abnormal or exceptional way, or forms a peak or increases significantly;
a morphological analysis method for extracting character strings from a digital document and for distinguishing, among those strings, those that correspond to morphemes or groups of morphemes and those that correspond to separators between morphemes or groups of morphemes;
a strings lookup method for determining, for each period identified by the period identification method, among character strings extracted by the morphological analysis method from digital documents inside the period, strings with higher frequencies among digital documents within the period compared to digital documents outside the period;
a label building method for building, for each period identified by the period identification method, a label from all or a sample of digital documents of the period, split according to the morphological analysis method, and from a subset or all of character strings determined the strings lookup method.

2. Method according to claim 1 characterized in that the method for distinguishing periods when the throughput varies in an abnormal or exceptional manner is based on a low-cut (or high-pass) filter based on discrete wavelets.

3. Method according to claim 1 characterized in that the method for distinguishing periods when the throughput varies in an abnormal or exceptional manner is based on the residual computation according to a periodic or quasi-periodic model of the throughput, which parameters are calculated by the least-squares method.

4. Method according to claim 1 characterized in that the morphological analysis method comprises at first an identification of the language of the digital document and then specialized methods to separate words according to document language.

5. Method according to claim 1 characterized in that the first step of the method for determining the character strings whose frequencies are higher for digital documents inside each period identified by the period identification method consists in eliminating character strings included in a list of stop-words.

6. Method according to claim 1 characterized in that the method for determining the character strings extracted by the morphological analysis method whose frequencies are higher for digital documents inside each period identified by the period identification method consists in computing the “TF-IDF” product from occurrences of character strings extracted by the morphological analysis method for digital documents inside the period compared to digital documents outside the period, and then selecting the character string or the character strings for which this product is the highest.

7. Method according to claim 1 characterized in that the method for building a label from digital documents and from a subset of the character strings from these documents consists in looking up the character string, contained in the digital documents and composed of a set of morphemes distinguished by the morphological analysis method, which maximizes a function defined as the sum of frequencies of all sub-strings in the set of digital documents.

8. Device for presenting to the operator a throughput chart and highlighting the main peaks, increases or abnormal or unusual variations in the throughput and displays, statically or interactively, labels associated to these peaks, increases or abnormal or unusual variations, and implementing:
a period identification method for identifying periods when the throughput of the stream of digital documents varies in an abnormal or exceptional way, or forms a peak or increases significantly;
a label building method for building, for each period identified by the period identification method, a label from all or a sample of digital documents of the period.

9. Device according to preceding claim characterized in that it is coupled to a customizable filtering system presenting to the operator a throughput chart of the subset of the stream resulting from the filtering, highlighting the main peaks, increases or abnormal or exceptional variations, and associating them with labels, and allowing the operator to adjust the filter to analyze more specifically the stream relative to the peaks to obtain more information about the peaks, or the remainder of the chart and possibly to indicate other peaks.

10. Device for implementing a method according to claim 1 characterized in that it is coupled to an alerting or notification system.

11. Device according to claim 8 and characterized in that it is coupled to an alerting or notification system.

12. Device according to claim 8 implementing:
a morphological analysis method for extracting character strings from a digital document and for distinguishing, among those strings, those that correspond to morphemes or groups of morphemes and those that correspond to separators between morphemes or groups of morphemes;
a strings lookup method for determining, for each period identified by the period identification method, among character strings extracted by the morphological analysis method from digital documents inside the period, strings with higher frequencies among digital documents within the period compared to digital documents outside the period;
and also characterized in that the label building method builds labels from all or a sample of digital documents of the period, split according to the morphological analysis method, and from a subset or all of character strings determined the strings lookup method.
